(19) United States
(12) Patent Application Publication
(10) Pub. No.: US 2014/0159623 A1
(43) Pub. Date: Jun. 12, 2014

(54) MOTOR DRIVING APPARATUS AND METHOD

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 13/770,877

(22) Filed: Feb. 19, 2013

(30) Foreign Application Priority Data
Dec. 10, 2012 (KR) 10-2012-0142917

(51) Int. Cl. H02P 6/20

(52) U.S. Cl. CPC H02P 6/205
USPC 318/400.11

(57) ABSTRACT

There are provided a motor driving apparatus and method capable of driving a motor at an optimal driving frequency at which back-electromotive force is generated by sweeping a driving frequency by a preset unit frequency interval during initial driving of the motor, the motor driving apparatus including: a frequency signal generating unit providing a frequency signal of which a frequency is set by a preset unit frequency interval; a driving signal generating unit generating a driving signal based on the frequency signal from the frequency signal generating unit; and a driving unit driving a motor according to the driving signal from the driving signal generating unit.

### CROSS-REFERENCE TO RELATED APPLICATIONS

This application claims the priority of Korean Patent Application No. 10-2012-0142917 filed on Dec. 10, 2012, in the Korean Intellectual Property Office, the disclosure of which is incorporated herein by reference.

### BACKGROUND OF THE INVENTION

1. Field of the Invention

The present invention relates to a motor driving apparatus and method capable of driving a motor at an optimal frequency.

2. Description of the Related Art

Recently, electric and electronic devices have been increasingly used in domestic, commercial and industrial settings.

In electric and electronic devices, such as a motor, a driving circuit may be used for driving a specific operation.

Generally, a motor is driven by rotating a rotor using a permanent magnet and a coil having polarities changed according to current applied thereto. Initially, a brush type motor in which a rotor is provided with a coil was provided. However, the brush type motor may have problems such as brush abrasion, spark generation, or the like, due to driving thereof.

Therefore, recently, a brushless direct current (BLDC) motor having various forms has been in general use. In the BLDC motor, a permanent magnet is used as a rotor and a plurality of coils are provided as a stator to induce rotation of the rotor.

In the case of the BLDC motor as described above, it is necessary to confirm a position of the rotor. To this end, a scheme of using back-electromotive force (BEMF) has widely been used.

However, in the case of driving a sensorless motor as in the case of the invention disclosed in the following related art document, the driving of the motor is controlled based on back-electromotive force generated when the motor is driven, but back-electromotive force may not be generated during initial driving of the motor, such that it may not be easy to optimally drive the motor.

### RELATED ART DOCUMENT

(Patent Document 1) Japanese Patent Laid-open Publication No. 2001-061291

### SUMMARY OF THE INVENTION

An aspect of the present invention provides a motor driving apparatus and method capable of driving a motor at an optimal driving frequency at which back-electromotive force is generated by sweeping a driving frequency by a preset unit frequency interval during initial driving of the motor.

According to an aspect of the present invention, there is provided a motor driving apparatus including: a frequency signal generating unit providing a frequency signal of which a frequency is set by a preset unit frequency interval; a driving signal generating unit generating a driving signal based on the frequency signal from the frequency signal generating unit; and a driving unit driving a motor according to the driving signal from the driving signal generating unit.

The motor driving apparatus may further include a detecting unit detecting back-electromotive force (BEMF) generated during the driving of the motor by the driving unit.

The motor driving apparatus may further include a dividing unit dividing the frequency from the frequency signal generating unit to transfer the divided frequency to the driving signal generating unit.

The frequency signal generating unit may include: a frequency generation controlling unit controlling generating of the frequency by the unit frequency interval; a current generating unit generating current according to the controlling of the frequency generation controlling unit; and a frequency generating unit generating a corresponding frequency according to the current generated by the current generating unit.

The frequency generating unit may include at least one or more inverters.

The frequency generating unit may include an odd number of inverters.

The current generating unit may include: a first current generator including a first current source group having a plurality of current sources and a first switch group having a plurality of switches providing current transfer paths for the plurality of current sources, respectively, according to the controlling of the frequency generation controlling unit; and a second current generator including a second current source group having a plurality of current sources and a second switch group having a plurality of switches providing current transfer paths for the plurality of current sources of the second current source group, respectively, according to the controlling of the frequency generation controlling unit.

According to another aspect of the present invention, there is provided a motor driving method including: driving a motor using a driving signal having a preset frequency; detecting back-electromotive force (BEMF) generated by the driving of the motor; and resetting the frequency of the driving signal by a preset unit frequency interval according to a level of the detected back-electromotive force.

In the resetting of the frequency, the frequency of the driving signal may be reset by the preset unit frequency interval until back-electromotive force having a desired level is detected.

The resetting of the frequency may be performed during initial driving of the motor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a motor driving apparatus according to an embodiment of the present invention;

FIG. 2 is a schematic configuration diagram of a frequency generating unit used in the motor driving apparatus according to the embodiment of the present invention;

FIG. 3 is a schematic configuration diagram of a current generating unit used in the motor driving apparatus according to the embodiment of the present invention;

FIG. 4 is a graph illustrating frequency setting of the motor driving apparatus according to an embodiment of the present invention; and

FIG. 5 is a flowchart illustrating a motor driving method according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same or like reference numerals will be used to designate the same or like elements.

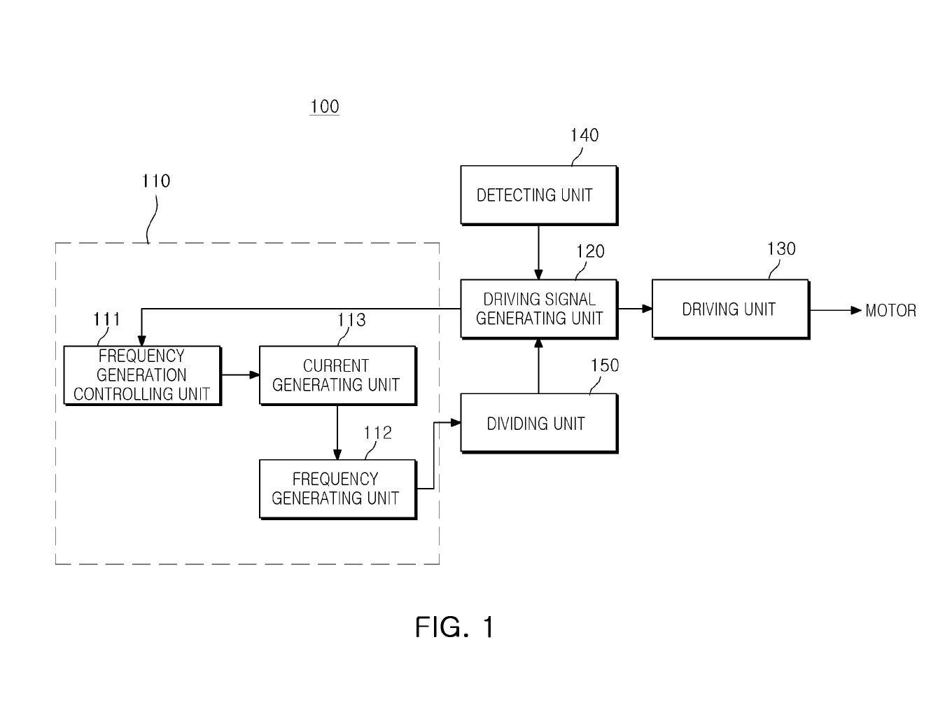

FIG. 1 is a schematic block diagram of a motor driving apparatus according to an embodiment of the present invention.

Referring to FIG. 1, a motor driving apparatus 100 according to the embodiment of the present invention may include a frequency signal generating unit 110, a driving signal generating unit 120, and a driving unit 130, and further include a detecting unit 140 and a dividing unit 150.

The frequency signal generating unit 110 may provide a frequency signal of which a frequency is set by a preset unit frequency interval, the driving signal generating unit 120 may generate a motor driving signal based on the frequency signal from the frequency signal generating unit 110, and the driving unit 130 may drive a motor according to the motor driving signal from the driving signal generating unit 120.

The frequency signal generating unit 110 may include a frequency generation controlling unit 111, a frequency generating unit 112, and a current generating unit 113.

The frequency generation controlling unit 111 may control current generation of the current generating unit 113 so that the frequency is generated by the unit frequency interval. The frequency generating unit 112 may generate the corresponding frequency according to the current generation of the current generating unit 113, and the current generating unit 113 may generate current according to the controlling of the frequency generation controlling unit 111.

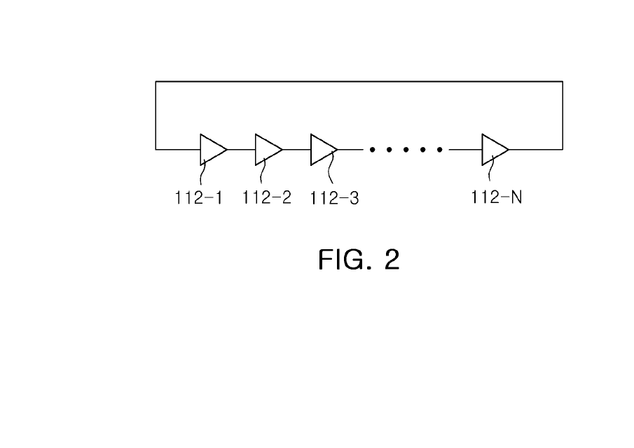

FIG. 2 is a schematic configuration diagram of a frequency generating unit used in the motor driving apparatus according to the embodiment of the present invention.

Referring to FIG. 2, the frequency generating unit 112 used in the motor driving apparatus 100 according to the embodiment of the present invention may include a plurality of inverters 112-1 to 112-N.

In addition, in view of inversion of an input signal, it may be preferable that the number of first to N-th inverters 112-1 to 112-N be odd.

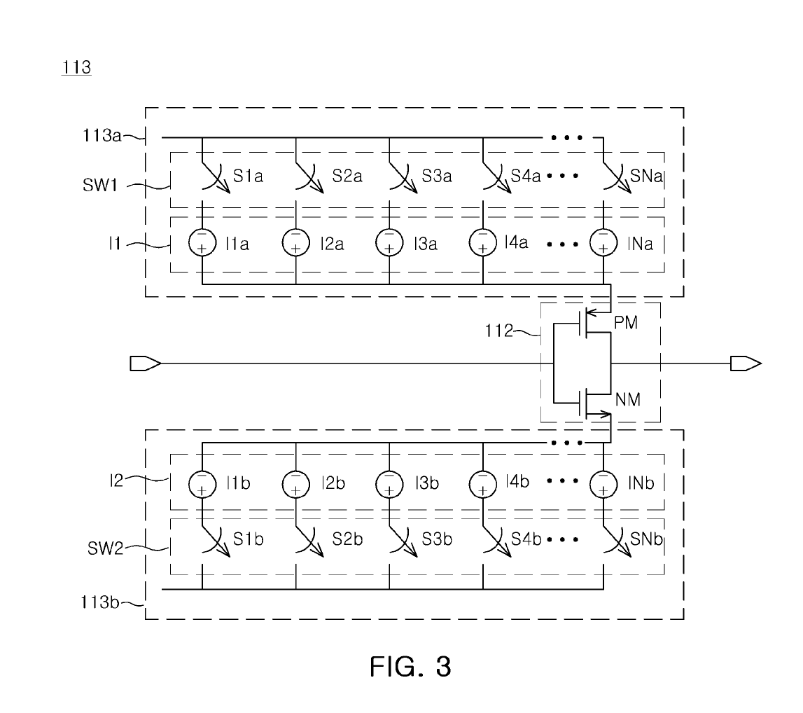

FIG. 3 is a schematic configuration diagram of a current generating unit used in the motor driving apparatus according to the embodiment of the present invention.

Referring to FIG. 3, the current generating unit 113 may include a first current generator 113a and a second current generator 113b.

The first current generator 113a may include a first current source group 11 and a first switch group SW1. Similarly, the second current generator 113b may include a second current source group 12 and a second switch group SW2.

The first current source group 11 may include first to N-th current sources I1a to INa, and the second current source group 12 may also include first to N-th current sources I1b to INb.

Similarly, the first switch group SW1 may include first and N-th switches S1a to SNa corresponding to the first to N-th current sources I1a to INa of the first current source group I1, respectively, and the second switch group SW2 may also include first and N-th switches S1b to SNb corresponding to the first to N-th current sources I1b to INb of the second current source group I2, respectively.

The first and N-th switches S1a to SNa of the first switch group SW1 and the first and N-th switches S1b to SNb of the second switch group SW2 may be switched according to the controlling of the frequency generation controlling unit 111, respectively.

The first to N-th current sources I1a to INa of the first current source group I1 and the first to N-th current sources I1b to INb of the second current source group I2 may provide the corresponding current to the inverter according to the switching of the first to N-th switches S1a to SNa of the first switch group SW1 and the first to N-th switches S1b to SNb of the second switch group SW2.

That is, the frequency generation controlling unit 111 may control the current to be supplied to the inverter of the frequency generating unit 112. Therefore, a frequency of a signal output from the inverter of the frequency generating unit 112 may be changed. In this case, the inverter of the frequency generating unit 112 may have a structure in which a P type metal oxide semiconductor field effect transistor (P-MOS FET) and an N type metal oxide semiconductor field effect transistor (N-MOS FET) are connected in series.

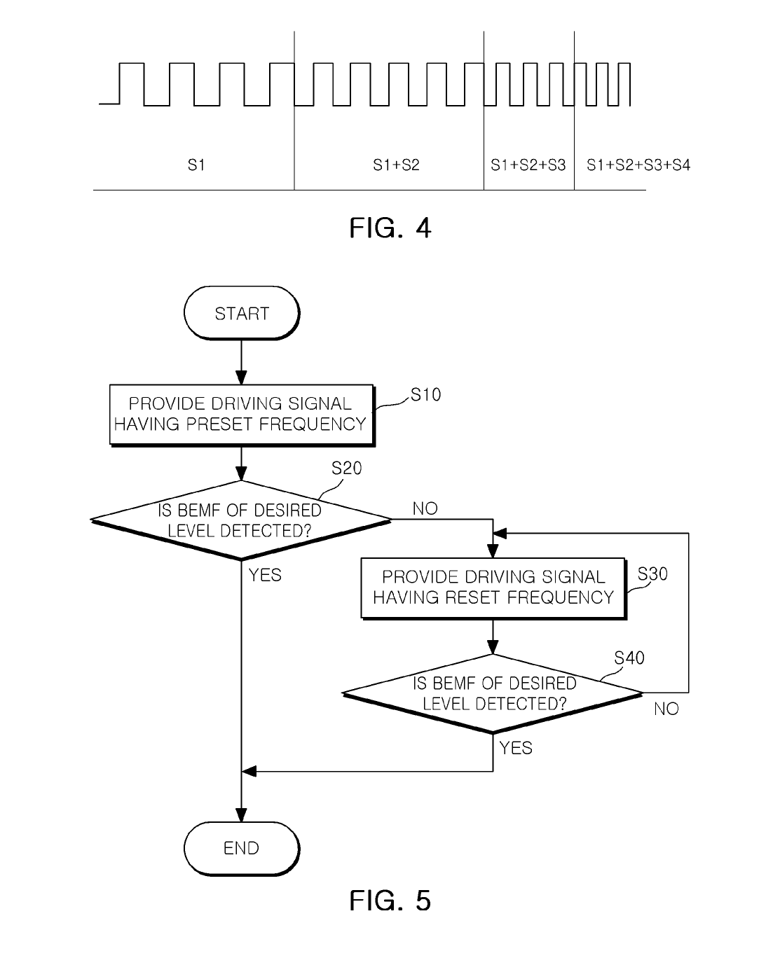

FIG. 4 is a graph illustrating frequency setting of the motor driving apparatus according to an embodiment of the present invention.

Referring to FIG. 4, current generation by the current generating unit 113 may be controlled by the frequency generation controlling unit 111, and current flowing to the inverter of the frequency generating unit 112 may be controlled, and a frequency may be set accordingly.

That is, the first switch S1a of the first switch group SW1 and the first switch S1b of the second switch group SW2 are turned on, and the other switches of the first and second switch groups SW1 and SW2 are turned off, such that the first current source I1a of the first current source group I1 and the first current source I1b of the second current source group I2 may provide corresponding current to the inverter of the frequency generating unit 112, and the inverter may perform an inverting operation corresponding thereto, whereby an output frequency may be changed.

In this case, current magnitudes of the first to N-th current sources I1a to INa of the first current source group I1 and the first to N-th current sources I1b to INb of the second current source group I2 may be set to be the same as each other or to be different from each other.

That is, in the case in which the current magnitudes of the first to N-th current sources I1a to INa of the first current source group I1 and the first to N-th current sources I1b to INb of the second current source group I2 are set to be the same as each other, when the first and second switches S1a and S2a of the first switch group SW1 and the first and second switches S1b and S2b of the second switch group SW2 are turned on and the other switches of the first and second switch groups SW1 and SW2 are turned off and the first and second current sources I1a and 12a of the first current source group I1 and the first and second current sources I1b and 12b of the second current source group I2 provide corresponding current to the inverter of the frequency generating unit 112, the frequency may betwice as fast (See S1+S2) as when the first switch S1a of the first switch group SW1 and the first switch S1b of the second switch group SW2 are turned on (See S1).

Similarly, when the first to third switches S1a to S1a and S1b to S1b of the respective switch groups are turned on, and the first to third current sources I1a to I3a and I1b to I3b of the respective current source groups provide the corresponding current, the frequency may be four times faster (See S1+S2+S3), and when the first to fourth switches S1a to S4a and S1b to S4b of the respective switch groups are turned on, and the first to fourth current sources I1a to I4a and I1b to I4b of the respective current source groups provide the corresponding current, the frequency may be eight times faster (See S1+S2+S3+S4).

In addition, in the case in which the current magnitudes of the first to N-th current sources I1a to INa of the first current source group I1 and the first to N-th current sources I1b to INb of the second current source group I2 are set to be different from each other, the frequency may be faster by a preset unit frequency interval, for example, by an interval of 100 Hz, than that in the case in which the first switch S1a of the first switch group SW1 and the first switch S1b of the second switch group SW2 are turned on.

The detecting unit 140 may detect back-electromotive force generated in the motor by the driving signal having the corresponding frequency to transfer the detection result to the driving signal generating unit 120. The dividing unit 150 may divide the frequency from the frequency signal generating unit 110 to transfer the divided frequency to the driving signal generating unit 120. Therefore, the driving signal generating unit 120 may precisely adjust the frequency interval.

FIG. 5 is a flowchart illustrating a motor driving method according to an embodiment of the present invention.

Referring to FIGS. 1 and 5, the frequency signal generating unit 110 may provide a frequency signal having a preset frequency to the dividing unit 150 during initial driving of a motor, the dividing unit 150 may divide the frequency of the frequency signal from the frequency signal generating unit 110 by a preset division ratio to transfer the divided frequency to the driving signal generating unit 120, the driving signal generating unit 120 may provide a driving signal having the divided frequency to the driving unit 130, and the driving unit 130 may drive the motor using the received driving signal (S10).

In this case, the detecting unit 140 may detect back-electromotive force (BEMF) generated during the driving of the motor to transfer the detecting result to the driving signal generating unit 120 when back-electromotive force having a desired level is detected, such that the driving signal generating unit 120 may provide a driving signal having a corresponding frequency to the driving unit 130 so that the driving of the motor is performed by the driving signal having the corresponding frequency (S20).

When the back-electromotive force having the desired level is not detected by the detecting unit 140, the driving signal generating unit 120 may request a change in frequency, the frequency signal generating unit 110 may generate a frequency signal having the next unit frequency interval to provide the generated frequency signal to the dividing unit 150, the dividing unit 150 may divide a frequency of the frequency signal from the frequency signal generating unit 110 by a preset division ratio to transfer the divided frequency to the driving signal generating unit 120, the diving signal generating unit 120 may provide a driving signal having the divided frequency to the driving unit 130, and the driving unit 130 may drive the motor using the received driving signal. These processes may be repeated until the detecting unit 140 detects the back-electromotive force having the desired level (S30 and S40).

For example, when the unit frequency is set to 2 Hz, a driving signal having a frequency of 2, 4, 6, or 8 Hz may drive the motor, and when the unit frequency is set to 10 Hz, a driving signal having a frequency of 10, 20, 30, or 40 Hz may drive the motor. The motor may be initially driven using a driving signal having a frequency at which back-electromotive force having a desired level is detected.

As set forth above, according to the embodiments of the present invention, a motor may be driven at an optimal driving frequency at which back-electromotive force (BEMF) is generated by sweeping a driving frequency by a preset unit frequency interval during the initial driving of the motor.

While the present invention has been shown and described in connection with the embodiments, it will be apparent to those skilled in the art that modifications and variations can be made without departing from the spirit and scope of the invention as defined by the appended claims.

What is claimed is:

1. A motor driving apparatus comprising:
a frequency signal generating unit providing a frequency signal of which a frequency is set by a preset unit frequency interval;
a driving signal generating unit generating a driving signal based on the frequency signal from the frequency signal generating unit; and
a driving unit driving a motor according to the driving signal from the driving signal generating unit.

2. The motor driving apparatus of claim 1, further comprising a detecting unit detecting back-electromotive force (BEMF) generated during the driving of the motor by the driving unit.

3. The motor driving apparatus of claim 1, further comprising a dividing unit dividing the frequency from the frequency signal generating unit to transfer the divided frequency to the driving signal generating unit.

4. The motor driving apparatus of claim 1, wherein the frequency signal generating unit includes:
a frequency generation controlling unit controlling generating of the frequency by the unit frequency interval;
a current generating unit generating current according to the controlling of the frequency generation controlling unit; and
a frequency generating unit generating a corresponding frequency according to the current generated by the current generating unit.

5. The motor driving apparatus of claim 4, wherein the frequency generating unit includes at least one or more inverters.

6. The motor driving apparatus of claim 5, wherein the frequency generating unit includes an odd number of inverters.

7. The motor driving apparatus of claim 4, wherein the current generating unit includes:
a first current generator including a first current source group having a plurality of current sources and a first switch group having a plurality of switches providing current transfer paths for the plurality of current sources, respectively, according to the controlling of the frequency generation controlling unit; and
a second current generator including a second current source group having a plurality of current sources and a second switch group having a plurality of switches providing current transfer paths for the plurality of current sources of the second current source group, respectively, according to the controlling of the frequency generation controlling unit.

8. A motor driving method comprising:
driving a motor using a driving signal having a preset frequency;
detecting back-electromotive force (BEMF) generated by the driving of the motor; and
resetting the frequency of the driving signal by a preset unit frequency interval according to a level of the detected back-electromotive force.

9. The motor driving method of claim 8, wherein in the resetting of the frequency, the frequency of the driving signal is reset by the preset unit frequency interval until back-electromotive force having a desired level is detected.

10. The motor driving method of claim 8, wherein the resetting of the frequency is performed during initial driving of the motor.
